(19) United States
(12) Patent Application Publication
(10) Pub. No.: US 2018/0267920 A1
(43) Pub. Date: Sep. 20, 2018

(54) EXPANSION COMPONENT

(71) Applicant: Lenovo (Beijing) Co., Ltd., Beijing (CN)

(72) Inventor: Hui LIN, Beijing (CN)

(21) Appl. No.: 15/924,483

(22) Filed: Mar. 19, 2018

(30) Foreign Application Priority Data
Mar. 17, 2017 (CN) 201710161436.2

(51) Int. Cl. G06F 13/40; G06F 9/4401; G06F 13/42; G06F 11/14

(52) U.S. Cl. CPC G06F 13/4068; G06F 9/4411; G06F 2201/84; G06F 11/1469; G06F 13/4282

(57) ABSTRACT

An expansion component includes a Baseboard Management Controller (BMC) including a first Serial Peripheral Interface (SPI) and a second storage device including a second SPI. A first storage device storing a main boot file of a Basic Input Output System (BIOS) is attached to the BMC. The second storage device stores an initialization boot file of the BIOS.

### CROSS-REFERENCES TO RELATED APPLICATION

This application claims priority to Chinese Patent Application No. 201710161436.2, filed on Mar. 17, 2017, the entire contents of which are incorporated herein by reference.

### TECHNICAL FIELD

The present disclosure relates to the field of electronic technology and, more particularly, to an expansion component, an electronic device, and a startup method.

### BACKGROUND

Unified Extensible Firmware Interface (UEFI) is a standard for detailed describing new types of interfaces in detail. UEFI is suitable for standard firmware interfaces for electronic devices. UEFI is a concept that is relative to Basic Input Output System (BIOS). UEFI is configured for automatically loading an operating system from a pre-boot operating environment on an electronic device, so as to simplify the boot process for saving time. Traditional BIOS technique is being replaced by UEFI technique. Many newly manufactured computers are now using UEFI. Using UEFI mode to install operating systems is a trend.

Currently, a size of the BIOS flash chip of an existing Intel x86 architecture server system is normally 16 MB˜32 MB due to the product cost limitation. Such size limits the functional expansion of UEFI BIOS. For example, importing an interface of a graphical BIOS needs a lot of storage space, which requires more flash chips and a higher cost. Therefore, similar expanded UEFI applications are stored in an Embedded Multi Media Card (eMMC) chip controlled by a Baseboard Management Controller (BMC). Such expanded UEFI applications are virtualized by the BMC as USB devices connected to a host, thereby being able to be called by the host. However, the virtual USB devices depend on USB buses connected between the BMC and the host. After the virtual USB devices being initialized and operated by the BIOS of the host, the codes of the expanded UEFI applications stored in the eMMC can be processed. As such, the starting of the existing Intel x86 architecture server system is time consuming.

### SUMMARY

In accordance with the disclosure, there is provided an expansion component includes a Baseboard Management Controller (BMC) including a first Serial Peripheral Interface (SPI) and a second storage device including a second SPI. A first storage device storing a main boot file of a Basic Input Output System (BIOS) is attached to the BMC. The second storage device stores an initialization boot file of the BIOS.

Also in accordance with the disclosure, there is provided a method for starting a Basic Input Output System (BIOS). The method includes accessing and loading an initialization boot file of the BIOS through a Serial Peripheral Interface (SPI) bus and reading a main boot file of the BIOS through the SPI bus. The main boot file is stored in a first storage device attached to a Baseboard Management Controller (BMC) of an electronic device. The initialization boot file is stored in a second storage device of the electronic device.

### BRIEF DESCRIPTION OF THE DRAWINGS

Various objectives, features, and advantages of the present disclosure can be more fully appreciated with reference to the detailed description of embodiments in connection with the following drawings, in which same reference numerals refer to the same or like elements unless otherwise specified. The following drawings are merely examples for illustrative purposes according to various disclosed embodiments and are not intended to limit the scope of the present disclosure.

FIG. 1 illustrates a schematic structural diagram of an example of expansion component in accordance with the present disclosure.

FIG. 2 illustrates a schematic structural diagram of another example of expansion component in accordance with the present disclosure.

FIG. 3 illustrates a schematic structural diagram of an example of electronic device in accordance with the present disclosure.

FIG. 4 illustrates a schematic flow diagram of an example of startup method of an electronic device in accordance with the present disclosure.

### DETAILED DESCRIPTION

Embodiments of the disclosure will be described in detail with reference to the accompanying drawings. The following description is made only by way of example, but does not limit the present disclosure. Various embodiments of the present disclosure and various features in the embodiments that do not conflict with each other can be combined and rearranged in various ways. Without departing from the spirit and scope of the present disclosure, modifications, equivalents, or improvements to the present disclosure are conceivable to those skilled in the art and are intended to be encompassed within the scope of the present disclosure.

In accordance with the present disclosure, an expansion component, an electronic device, and a startup method are provided to improve the startup efficiency of the electronic device.

In some embodiments, the expansion component can include a chipset on a motherboard of an electronic device, such as a component of an Intel chipset. The expansion component can be coupled to a central processing unit (CPU) of the electronic device and/or other components, such as a memory, a graphics card, etc. The electronic device can be any suitable device, such as a server or a mobile terminal, etc.

In some embodiments, a chipset includes a South Bridge and a North Bridge. The chipset can include multiple chips that integrate complex electronic circuits and components. The chipset can determine the function of the motherboard, and can even affect the performance of the entire computer system.

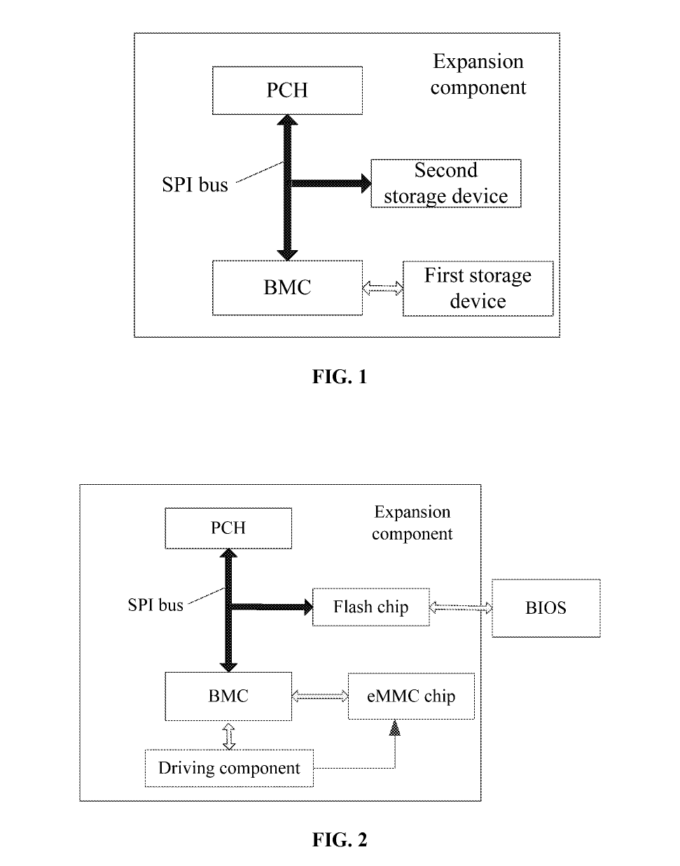

FIG. 1 illustrates a schematic structural diagram of an example of expansion component in accordance with the present disclosure. The expansion component includes a Platform Controller Hub (PCH), a Baseboard Management Controller (BMC) including a first storage device, a second storage device, and a Serial Peripheral Interface (SPI) bus. The SPI bus can be used for connecting the PCH, the BMC, and the second storage device. In some embodiments, the PCH can be a part of the chipset on the motherboard. The chipset can be connected to the CPU (not shown in FIG. 1) of an electronic device.

The BMC can be a specialized service processor. The BMC can use one or more sensors to monitor the status of an electronic device, a network server, or any other hardware-driven device, and can communicate with a system administrator through a separate connection line.

In some embodiments, the BMC may include a first SPI interface affixed on a BMC chip. The BMC can be coupled to the PCH through the first SPI interface. The first storage device can be attached to the BMC for storing a main boot file of the BIOS.

In some embodiments, the first storage device may be an eMMC chip attached to the BMC. The eMMC chip, as a file system of the BMC, can have a relatively large storage space. The storage space of the eMMC chip can be more than 4 GB. Therefore, the eMMC chip can be used as a flash expansion of a BIOS ROM. The main boot file stored in the eMMC chip can be used for the main functions of the BIOS, such as Power On Self Test (POST), etc. In some embodiments, the eMMC chip can be referred as a Main BIOS. For example, the eMMC chip may be denoted as MainBIOS (FV_MAIN).

The second storage device may be a physical flash chip that includes a second SPI interface. Thus, the second storage device may be considered as an SPI flash chip. The second storage device can be used to store an initialization boot file of the BIOS. Such that the second storage device can be referred as a BIOS SPI flash. The initialization boot file can be a part of Bootblock of the BIOS, and can be denoted as BootBlock (FV_BB). The initialization boot file can have a size of several tens of KB. The BootBlock can be configured for basic hardware initialization, and may further configured for checking whether the Main BIOS is damaged.

In some embodiments, the PCH, the BMC, and the second storage device can be coupled to each other through the SPI bus. Therefore, during a startup process of the BIOS, the second storage device and the files stored in the first storage device attached to the BMC can be accessed through the SPI bus.

In some embodiments, a first logical storage address of the main boot file in the first storage device and a second logical storage address of the initialization boot file in the second storage device can be successive. Intel chipset supports a successive addressing mode for two SPI flashes. When the Intel chipset writes the BIOS, the Intel chipset can write one BIOS file into two storage devices corresponding to two SPI interfaces, respectively, based on the addresses of the BIOS files. As such, the corresponding storage addresses of the BIOS files in the two storage devices can be successive.

In some embodiments, the UEFI BIOS ROM can logically include three parts: BootBlock (FV_BB), MainBIOS (FV_MAIN), and Non-Volatile Random Access Memory (NVRAM) (FV_NV). In the BIOS compilation process, the BootBlock (FV_BB), the MainBIOS (FV_MAIN), and the NVRAM (FV_NV) can be combined to form a complete BIOS ROM using a tool and can be assigned successive addresses as shown in Table 1.

TABLE 1

| Storage address | File |
|---|---|
| 000000-000FFF | NVRAM |
| 001000-6FFFFF | MainBIOS (FV_MAIN) |
| 700000-7FFFFF | BootBlock (FV_BB) |

FIG. 2 illustrates a schematic structural diagram of another example of expansion components in accordance with the present disclosure;

In some embodiments, as shown in FIG. 2, the expansion component further includes a driving component attached to the BMC. The driving component can be used for driving the first storage device to respond to the first SPI interface when the CPU accesses the BMC through the SPI bus. The driving component can convert the CPU's access to the first SPI interface into file reading and writing in the eMMC chip attached to the BMC.

For example, the eMMC chip attached to the BMC that can be accessed through the BMC's Host SPI interface can be defined as the first SPI flash. The BIOS SPI flash can be defined as the second SPI flash. The driving of the Host_SPI-eMMC attached to the BMC can simulate the SPI flash chip to respond to the read/write of the second SPI flash by the host. For example, the driving component can determine whether a received operation is a read/write operation to the first storage device by examining the received address. If so, the read/write operation can be converted into a read/write operation to the eMMC chip attached to the BMC through the SPI interface.

Therefore, during the BIOS boot process, the BootBlock (FV_BB) part can be executed on the SPI flash. After the BootBlock (FV_BB) part is completed, the initialization of the system memory is implemented. Then the MainBIOS (FV_MAIN) part can be copied to memory to be executed. As such, only the reading of the first storage device (i.e., the eMMC chip) is involved, and no operation is executed on the first storage device. That is, the implementation of the Host_SPI-eMMC driver attached to the BMC can be simplified. Thus, according to an order of storage addresses, the CPU can successively access, through the SPI bus, the second SPI interface for executing the initialization boot file, and the first SPI interface of the BMC for reading the main boot file from the first storage device. Access through the SPI bus has a high speed and thus can improve the startup efficiency.

In some embodiments, the motherboard can include the Basic Input Output System (BIOS). The BIOS can include a set of programs written in a Read-Only Memory (ROM) of the motherboard of the electronic device as a firmware. The BIOS can store the computer's basic input and output procedures, the self-test program after booting, and the self-starting program of the system. The BIOS can read and write specific system setup information from the Complementary Metal Oxide Semiconductor (CMOS) for providing the basic and direct hardware setup and control for the computer. Thus, the second storage device may be a storage device coupled to the BIOS or may be a storage device of the BIOS. As shown in FIG. 2, the BMC is able to communicate with the BIOS through the second SPI interface.

Optionally, the pin voltage level of the second storage device may be set to a preset level, such as a high level or a low level, to set the access status of the second storage device to a read-only status.

For example, the SPI flash chip storing the BootBlock (FV_BB) can have a write-protected pin. The write-protected pin can be set as a high level or a low level to turn the status of the SPI flash chip to a read-only status for preventing writing. In such a case, a potential damage to the MainBIOS (FV_MAIN) part of the eMMC chip may not affect the BootBlock (FV_BB) part.

In some embodiments, in addition to being responsible for basic hardware initialization, the initialization boot file BootBlock (FV_BB) can also verify whether the Main BIOS is damaged. If the Main BIOS is damaged, a recovery mode can be initiated. Thus, when the main boot file fails, the initialization boot file of the second storage device can be used to recover the main boot file in the first storage device through the SPI bus.

According to the disclosure, the eMMC chip can be used as an extension of the BIOS ROM flash, and the BIOS boot file can be separately stored in the BIOS SPI flash chip and the eMMC chip attached to the BMC. The BootBlock (FV_BB) stored in the SPI flash chip can have a relatively small size, while the MainBIOS (FV_MAIN) having a relatively large size is stored in the eMMC chip attached to the BMC. Comparing to the existing technique that the entire BIOS boot file is stored in the SPI flash chip, a device consistent with the disclosure can have a lower cost of the SPI flash chip.

Further, during the startup process, the CPU can access the boot file through the corresponding SPI interfaces of different storage devices by using the SPI bus. Without waiting for the BIOS to complete the USB initialization and devices enumeration, the main boot file stored in the eMMC chip can be directly copied to the memory to be executed. As such, the dependence on USB can be eliminated, and the efficiency of the startup process and the user experience can be improved.

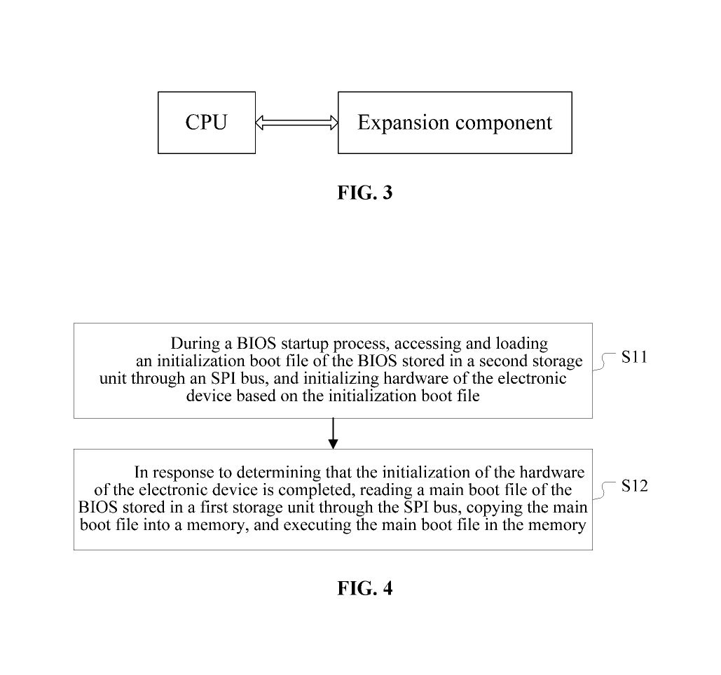

FIG. 3 illustrates a schematic structural diagram of an example of electronic device in accordance with the present disclosure. As shown in FIG. 3, the electronic device includes a CPU and an expansion component.

In some embodiments, the CPU and the expansion component can be arranged on the motherboard of the electronic device. The expansion component can be a component in a chipset, and can include an expansion component consistent with the disclosure, such as one of the above-described examples of expansion component. For description of the structure, reference can be made to the embodiments described above in connection with FIGS. 1 and 2.

FIG. 4 illustrates a schematic flow diagram of an example of startup method of an electronic device in accordance with the present disclosure. The startup method can be implemented in, for example, the electronic device shown in FIG. 3.

As shown in FIG. 4, at S11, during a BIOS startup process, the initialization boot file of the BIOS stored in the second storage device is accessed and loaded through the SPI bus, and the hardware of the electronic device is initialized based on the initialization boot file.

At S12, in response to determining that the initialization of the hardware of the electronic device is completed, the main boot file of the BIOS stored in the first storage device is read through the SPI bus, and is copied into a memory to be executed. The first storage device is attached to the BMC coupled to the CPU. The CPU, the BMC, and the second storage device are coupled to each other through the SPI bus.

In some embodiments, the first storage device of the electronic device may include an eMMC chip attached to the BMC in the chipset of the motherboard. The second storage device may include a flash chip, such as a memory chip of the BIOS. The SPI bus can be used for interconnection and communication among the first storage device, the BMC, and the CPU.

Optionally, before the process at S11, the BIOS can be written in a BIOS compilation process using a tool. The initialization boot file included in the BIOS boot file can be written into the second storage device with the second logical storage address. The main boot file included in the BIOS boot file can be written into the first storage device with the first logical storage address. The first logical storage address and the second logical storage address can be successive.

The initialization boot file can be the Bootblock part of the BIOS, which can be denoted as BootBlock (FV_BB). The BootBlock (FV_BB) may have a few tens of KB. The BootBlock can be responsible for basic hardware initialization. The BootBlock can also be used to check whether the Main BIOS part is damage.

The main boot file can be used for the main functions of the BIOS, such as Power On Self Test (POST), etc. In some embodiments, the main boot file used for the main functions of BIOS can be referred as Main BIOS, denoted as MainBIOS (FV_MAIN).

In some embodiments, both of the first storage device and the second storage device may be regarded as flashes. The Intel chipset supports a continuous addressing mode for two SPI flashes. Therefore, one BIOS file can be written into two corresponding SPI storage devices automatically according to an order of the storage addresses.

For example, the boot file BootBlock (FV_BB) that may have a few tens of KB can be stored in the BIOS Flash. The MainBIOS (FV_MAIN) that may have a larger size can be stored in the eMMC chip attached to the BMC. The storage addresses of the BootBlock (FV_BB) and the MainBIOS (FV_MAIN) can be successive.

In some embodiments, the BMC, the second storage device, and the CPU can communicate with each other through the SPI bus. In response to receiving a boot operation of the electronic device, the BIOS can be started first. The BIOS can initialize the hardware, conduct self-test, and so on. The corresponding boot files can be accessed according to an order of the storage addresses.

For example, in the process of starting the BIOS, the BootBlock (FV_BB) part can be executed on the SPI flash chip. Completing the BootBlock (FV_BB) realizes the initialization of the system memory. Then, the MainBIOS (FV_MAIN) in the eMMC attached to the BMC can be read through the SPI, and can be copied into a memory to be executed. The above described access mode can be more convenient and more efficient.

In the process of starting the BIOS, the MainBIOS (FV_MAIN) in the eMMC chip attached to the BMC is read and written without an operation executed in the eMMC chip attached to the BMC. Thus, the driving of the Host_SPI-eMMC attached to the BMC can be simplified. Host_SPI refers to the SPI interface from the BMC to the Host.

Optionally, in the process of starting the BIOS, the electronic device may also detect whether there is a failure in the main boot file of the second storage device. If there is a failure in the main boot file, the main boot file can be restored based on the initialization boot file through the SPI bus.

According to the disclosure, by using the dual SPI flash successive addressing technology supported by Intel chipsets and the Host SPI interfaces supported by the BMC chip, the Bootblock (FV_BB) part of the BIOS can be stored in a physical SPI flash chip, while the Main BIOS (FV_MAIN) can be stored in the eMMC chip attached to the BMC. The BMC can convert an access by the Host to the BMC Host SPI interface to a read/write operation to the eMMC chip attached to the BMC, which can be a task completed by the driver of Host SPI-eMMC attached to the BMC. The BootBlock (FV_BB) of the BIOS can have a few tens of KB, and the eMMC chip used as a file system of the BMC can be more than 4 GB. Thus, the cost of SPI flash chip can be saved. By using the SPI bus, the dependence on the Host USB bus can be eliminated. The MainBIOS (FV_MAIN) can be managed by the BMC. Therefore, the upgrade, maintenance, and security check of the MainBIOS (FV_MAIN) can be simple.

Additionally, the SPI chip can have a write-protected pin. The write-protected pin can be set to a high level or a low level to turn the status of the SPI flash chip to a read-only status for preventing writing. As such, a potential damage to the MainBIOS (FV_MAIN) part of the eMMC chip may not affect the BootBlock (FV_BB) part. The recovery of the MainBIOS (FV_MAIN) can be realized by using the BootBlock (FV_BB).

Those skilled in the art can appreciate that, the disclosed method in various embodiments can be executed by a hardware product, by a software product, or by a product including a hardware module and a software module. The software module may reside in any suitable storage/memory medium, such as a random access memory, a flash memory, a read-only memory (ROM), a programmable ROM, an electrically erasable programmable memory, a register, a compact-disc ROM, an optical storage device, etc.

The flowcharts in the figures illustrate various embodiments of the disclosed method, as well as architectures, functions and operations that can be implemented by a computer program product. In this case, each block of the flowcharts may represent a module, a code segment, a portion of program code. Each module, each code segment, and each portion of program code can include one or more executable instructions for implementing logical functions.

In some embodiments, the functions illustrated in the blocks be executed or performed in any order or sequence not limited to the order and sequence shown in the figure and described above. For example, two consecutive blocks may actually be executed substantially simultaneously where appropriate or in parallel to reduce latency and processing times, or even be executed in a reverse order depending on the functionality involved in.

Each block in the flowcharts, as well as the combinations of the blocks in the flowcharts, can be realized by a dedicated hardware-based system for executing specific functions, or can be realized by a dedicated system combined by hardware and computer instructions.

The disclosure also provides a computer program product that includes computer-readable storage medium storing program codes. The program code includes instructions for performing a startup method consistent with the disclosure, such as one of the above-described methods. For example, the present disclosure provides a computer-readable storage medium (e.g., that is not a transitory signal) containing computer-executable instructions that, when executed by a hardware processor, cause the hardware processor to perform a startup method consistent with the disclosure, such as one of the above-described methods. The storage medium can include, for example, a CD-ROM, a hard disk, or a flash drive. The method can include the following processes.

During the BIOS startup process, the initialization boot file of the BIOS stored in the second storage device is accessed and loaded through the SPI bus, and the hardware of the electronic device is initialized based on the initialization boot file.

In response to determining that the initialization of the hardware of the electronic device is completed, the main boot file of the BIOS stored in the first storage device attached to the BMC is read through the SPI bus, and copied into a memory to be executed. The BMC that is coupled to the CPU. The CPU, the BMC, and the second storage device are coupled to each other through the SPI bus.

The computer-readable storage medium also stores additional computer-executable instructions that are executed by the hardware processor before executing the above-described computer instructions corresponding to accessing and loading the initialization boot file stored in the second storage device through the SPI bus during the BIOS startup process. The execution of the additional computer-executable instructions can include the following processes.

The BIOS is written, such that the initialization boot file included in the BIOS boot file is written to the second storage device with the second logical storage address, while the main boot file included in the BIOS boot file is written to the first storage device with the first logical storage address. The first logical storage address and the second logical storage address are successive.

Optionally, the computer-readable storage medium also stores additional computer-executable instructions that are executed by the hardware processor simultaneously with the execution of the computer-executable instructions that cause the initialization boot file of the BIOS stored in the second storage device to be accessed and loaded through the SPI bus for initializing the computer hardware of the electronic device. The execution of the additional computer-executable instructions can include the following processes.

The main boot file is checked to determine whether the main boot file is damaged. In response to determining that the main boot file is damaged, the main boot file is recovered based on the initialization boot file through the SPI bus.

Those skilled in the art can understand that, for convenience and simplicity of description, reference can be made to the corresponding processes of various embodiments of the disclosed method described above for the specific working process of the systems, devices, and units described above.

In various embodiments provided herein, it should be understood that, the disclosed system, medium, and method can be realized through other means. The disclosed embodiments of the present disclosure are merely illustrative.

If the functions are implemented as software functional units, and being used or sold as a standalone product, the product can be stored in a computer readable storage medium. Based on this understanding, the technical solutions consistent with the disclosure can be embodied in a form of a computer software product.

The computer software product can be stored in a computer-readable storage medium (e.g., that is not a transitory signal), including multiple instructions to instruct a computer device, such as a hardware processor, a personal computer, a server, or a network equipment, to perform all or part of a method consistent with the disclosure, such as one of the above-described methods. The aforementioned storage medium can include, for example, a flash drive, a removable hard disk, a read only memory (ROM), a random access memory (RAM), a floppy disk, a CD-ROM, or any other suitable medium that can store program codes.

The provision of the examples described herein (as well as clauses phrased as “such as,” “e.g.,” “including,” or the like) should not be interpreted as limiting the disclosure to the specific examples; rather, the examples are intended to illustrate only some of many possible aspects.

Although the present disclosure has been described and illustrated in the foregoing illustrative embodiments, it is understood that the present disclosure has been made only by way of example, and that numerous changes in the details of embodiment of the present disclosure can be made without departing from the spirit and scope of the present disclosure. Features of the disclosed embodiments can be combined and rearranged in various manners. Without departing from the spirit and scope of the present disclosure, modifications, equivalents, or improvements to the present disclosure are conceivable to those skilled in the art and are intended to be encompassed within the scope of the present disclosure.

What is claimed is:

1. An expansion component, comprising:
a Baseboard Management Controller (BMC) including a first Serial Peripheral Interface (SPI), wherein a first storage device storing a main boot file of a Basic Input Output System (BIOS) is attached to the BMC; and
a second storage device including a second SPI and storing an initialization boot file of the BIOS.

2. The expansion component of claim 1, further comprising:
a Platform Controller Hub (PCH), wherein the PCH is to be coupled with a central processing unit (CPU); and
an SPI bus coupling the PCH, the BMC, and the second storage device,
wherein, during a startup process of the BIOS, the initialization boot file is executed as a result of the second SPI being accessed through the SPI bus, and the main boot files stored in the first storage device is read as a result of the first SPI being accessed through the SPI bus.

3. The expansion component of claim 2, wherein:
a size of the first storage device is larger than a size of the second storage device.

4. The expansion component of claim 3, wherein:
the first storage device includes an Embedded Multi Media Card (eMMC) chip attached to the BMC, and
the second storage device includes a flash chip.

5. The expansion component of claim 3, wherein:
an accessing status of the second storage device is a read-only status.

6. The expansion component of claim 2, further comprising:
a driving component attached to the BMC, wherein the driving component drives the first storage device to respond to the first SPI interface in response to the BMC being accessed through the SPI bus.

7. The expansion component of claim 1, wherein:
a first logical storage address of the main boot file in the first storage device and a second logical storage address of the initialization boot file in the second storage device are successive.

8. The expansion component of claim 1, wherein:
a voltage level of a pin of the second storage device is set to a high level or a low level to set the second storage device to a read-only status.

9. The expansion component of claim 1, wherein:
the initialization boot file is used to recover, in response to determining that the main boot file is damaged, the main boot file stored in the first storage device through the SPI bus.

10. An electronic device, comprising:
a central processing unit (CPU); and
an expansion component of claim 1 and coupled with the CPU.

11. A method for starting a Basic Input Output System (BIOS) comprising:
accessing and loading an initialization boot file of the BIOS through a Serial Peripheral Interface (SPI) bus; and
reading a main boot file of the BIOS through the SPI bus,
wherein:
the main boot file is stored in a first storage device attached to a Baseboard Management Controller (BMC) of an electronic device, and
the initialization boot file is stored in a second storage device of the electronic device.

12. The method of claim 11, wherein:
a central processing unit (CPU) of the electronic device, the BMC, and the second storage device are coupled to each other through the SPI bus.

13. The method of claim 11, further comprising:
copying the main boot file into a memory; and
executing the main boot file in the memory.

14. The method of claim 11, further comprising, before accessing and loading the initialization boot file:
writing the main boot file included in a boot file of the BIOS into the first storage device with a first logical storage address; and
writing the initialization boot file included in the boot file of the BIOS into the second storage device with a second logical storage address,
wherein the first logical storage address and the second logical storage address are successive.

15. The method of claim 11, further comprising:
initializing hardware of the electronic device based on the initialization boot file,
wherein reading the main boot file includes reading the main boot file in response to determining that the hardware of the electronic device has been initialized.

16. The method of claim 15, further comprising, while initializing the hardware of the electronic device:
determining whether the main boot file is damaged; and
in response to determining that the main boot file is damaged, recovering the main boot file based on the initialization boot file through the SPI bus.
